(19) United States
(12) Patent Application Publication
(10) Pub. No.: US 2016/0132000 A1
(43) Pub. Date: May 12, 2016

(54) FIXING LIQUID TONER

(71) Applicant: HEWLETT-PACKARD DEVELOPMENT COMPANY, L.P., Houston,, TX (US)

(72) Inventors: Eric G. Nelson, Eagle, ID (US); Bruce J. Jackson, Middleton, ID (US); Stanley D. Morse, Star, ID (US)

(21) Appl. No.: 14/442,072

(22) PCT Filed: Nov. 14, 2012
(86) PCT No.: PCT/US2012/065032

§ 371 Date: May 11, 2015

(51) Int. Cl. G03G 15/20

(52) U.S. Cl. CPC G03G 15/2007

(57) ABSTRACT

In one embodiment, a printer includes a device configured to form a semisolid toner film on a print substrate and a fixer configured to, without contacting the toner film, soften the toner film on the print substrate until polymers in the toner are mobile enough to allow polymer functional groups to bond with the print substrate.

### BACKGROUND

Liquid electro-photographic (LEP) printing uses a special kind of ink to form images on paper or other print substrates. LEP ink usually includes colored polymer particles dispersed in a carrier liquid. The polymer particles are commonly referred to as toner particles and, accordingly, LEP ink is often called liquid toner. The LEP printing process involves placing an electrostatic pattern of the desired printed image on a photoconductor and developing the image by applying a thin layer of liquid toner to the charged photoconductor. Charged toner particles in the liquid adhere to the pattern of the desired image on the photoconductor. The liquid toner image is transferred from the photoconductor to a heated intermediate transfer member, evaporating much of the carrier liquid to dry the toner film to a near solid. The toner film is then pressed on to the cooler substrate and frozen in place at a nip between the intermediate transfer member and the substrate.

### DRAWINGS

FIGS. 1 and 2 illustrate an LEP printer that includes one example of a new post print toner fixer.

FIG. 3 is a line graph illustrating one example relationship between time and temperature to improve toner adhesion using a post print fixer such as the one shown in FIGS. 1 and 2.

FIG. 4 is a line graph illustrating one example temperature profile across the thickness of a paper print substrate at the exit of an IR heater type post print toner fixer.

FIG. 5 is a line graph illustrating one example heating and cooling profile for a paper print substrate at the exit of an IR heater type post print toner fixer.

FIG. 6 is a line graph illustrating example power consumption curves as a function of heat flux for a post printer toner fixer using different weight paper print substrates.

FIG. 7 illustrates an LEP printer that includes another example of a new post print toner fixer for duplex printing.

FIGS. 8 and 9 are flow charts illustrating example printing methods using a fixer such as the fixer shown in the printer of FIGS. 1 and 2.

The same part numbers designate the same or similar parts throughout the figures.

### DESCRIPTION

ElectroInk® and other liquid toners developed by Hewlett-Packard Co. for use in HP Indigo® printing presses adhere to a wide variety of print substrates. Still, there are some print substrates that these liquid toners do not adhere to well. A new technique has been developed to help improve the adhesion of liquid toners to expand the variety of print substrates that can be used effectively for LEP printing. Accordingly, examples of the new technique will be described with reference to liquid toner and LEP printing. Examples of the new technique, however, are not limited to liquid toners for LEP printing, but may be implemented with other liquid toners and with other devices for dispensing liquid toner.

In the past, the adhesion of liquid toner to the print substrate has been controlled by materials and with print process settings such as drum temperatures, ITM blanket temperature and swelling and release characteristics, ventilation, and drying. Because toner adhesion previously had to be balanced with other printing parameters, the design space for improving adhesion was limited and sometimes meant losing performance in other areas to achieve gains in adhesion. Examples of the new technique described below help de-couple improved toner adhesion from other printing performance characteristics through the use of a post-print process that helps maintain the integrity of the main printing process.

Testing has shown that some new and otherwise desirable liquid toners reduce the overall adhesion of the toner to the substrate compared to other toners. It has been discovered, however, that the toner film on the surface of the print substrate can be heated to a temperature at which polymers in the toner flow, to improve the adhesion of these and other toners without contact or pressure and under conditions not likely to degrade print quality or impede printer throughput. In addition, it has been shown that using a high heat flux to heat the toner film raises the toner film to the desired flow temperatures without also heating the bulk of the print substrate, thus minimizing energy consumption and reducing or even eliminating the need for active cooling. Heating the toner film very fast generates polymer flow on a very small scale, without bulk flow, to help reduce or eliminate any visible change in the gloss, color, or other attributes of the toner image. Also, since it is possible to heat only the top surface of the print substrate, there is very little undesirable added drying of the toner film.

Accordingly, in one example, a new printer includes an LEP print engine or other image forming device configured to form a solid or semisolid toner film on a print substrate and a fixer configured to soften the toner film on the print substrate until polymers in the toner flow enough to contact the print substrate. In another example, a new printing method includes applying liquid toner to a first substrate, drying the liquid toner to form drier toner on the first substrate; transferring the drier toner from the first substrate to the front surface of a second substrate, and heating the toner on the second substrate to at least 100° C. without also heating the back surface of the second substrate to 100° C. or more. These and other examples shown in the figures and described below illustrate but do not limit the invention which is defined in the Claims following this Description.

As used in this document, “liquid toner” means a colloidal system of charged or non-charged particles in a liquid carrier.

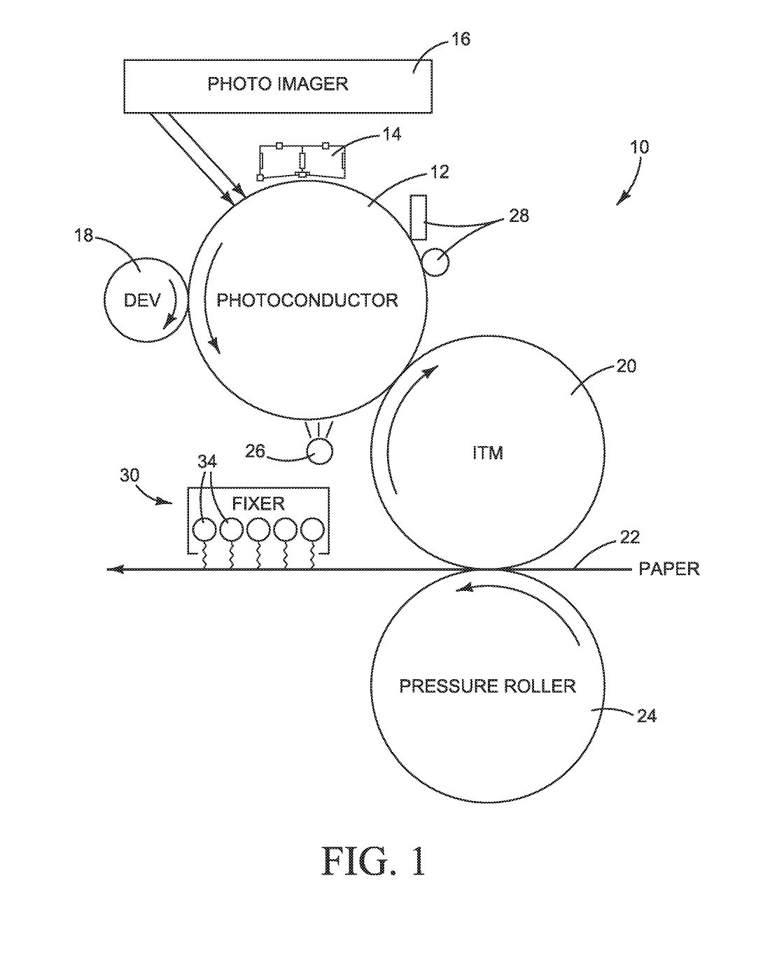

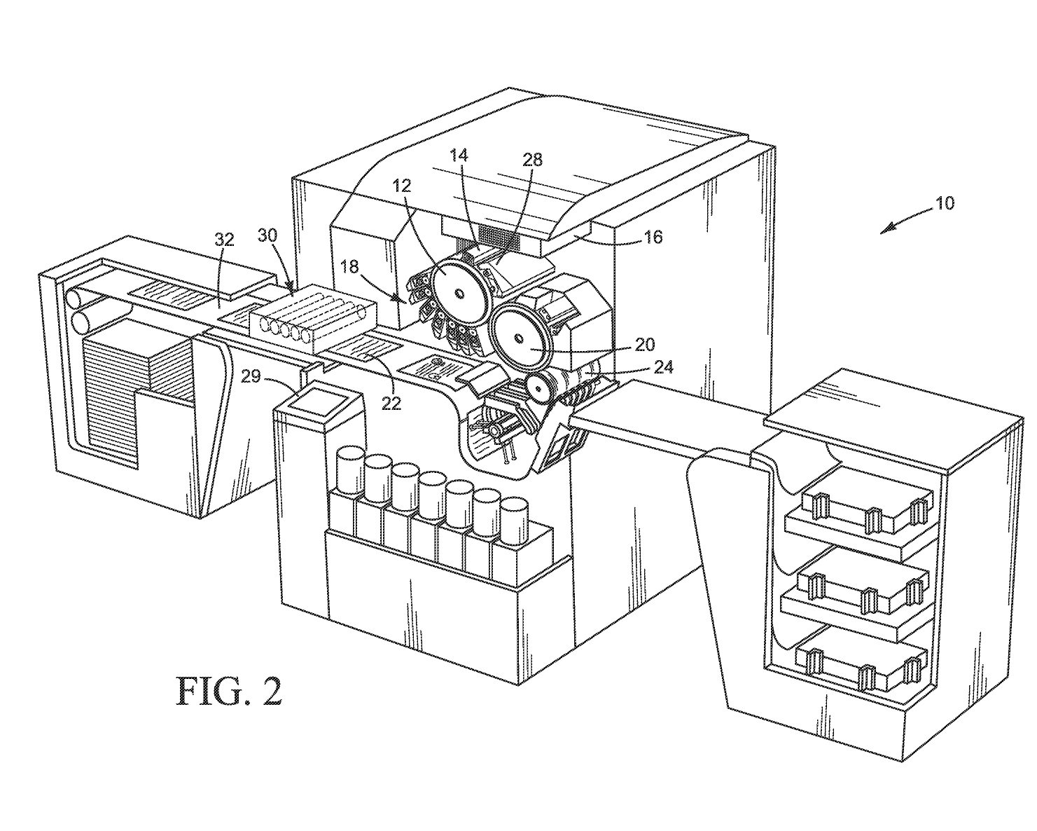

FIGS. 1 and 2 illustrate an LEP printer 10 that includes one example of a new post print toner fixer. Referring to FIGS. 1 and 2, in an LEP printer 10 a uniform electrostatic charge is applied to a photoconductive surface, the outer surface of a photoconductor drum 12 for example, by a scorotron or other suitable charging device 14. A scanning laser or other suitable photo imaging device 16 exposes selected areas on photoconductor 12 to light in the pattern of the desired printed image. A thin layer of liquid toner is applied to the patterned photoconductor 12 using a developer 18. Developer 18 represents generally a typically complex unit that supplies different color toners to a series of small rollers that rotate against photoconductor 12. The latent image on photoconductor 12 is developed through the application of liquid toner which adheres to the charged pattern on photoconductor 12, developing the latent electrostatic image into a toner image. The toner image is transferred from photoconductor 12 to an intermediate transfer drum/member (ITM) 20 and then from intermediate transfer member 20 to sheets or a web of paper or other print substrate 22 as it passes between intermediate transfer member 20 and a pressure roller 24. A lamp or other suitable discharging device 26 removes residual charge from photoconductor 12 and toner residue is removed at a cleaning station 28 in preparation for developing the next image or for applying the next toner color plane.

Printer 10 also includes a controller 29 (FIG. 2) and a fixer 30. Controller 29 represents generally the programming, processors and associated memories, and the electronic circuitry and components needed to control the operative elements of a printer 10. Intermediate transfer member 20 usually will include a removable, replaceable blanket wrapped around a drum. The comparatively soft, compliant blanket is heated to evaporate most of the liquid carrier component of the toner so that the toner dries to a very thin semisolid film before being transferred to print substrate 22. The toner film, for example, is dried to about 90% solid. Usually only about 3-10% of the original liquid carrier remains after drying. The toner film on the hot ITM blanket is pressed onto the cooler substrate 22 and frozen in place at the nip between transfer member 20 and pressure roller 24.

After the toner image has been applied to substrate 22, substrate 22 passes through fixer 30 where the toner film is heated until it softens enough to allow polymers in the toner to flow, exposing polymer functional groups to the surface of print substrate 22 to increase adhesion. In order for this exposing to occur, the polymers must be mobile enough to allow polymer functional groups to bond with the paper. A thermal softening of the toner film on substrate 22 at fixer 30 allows polymers in the toner to flow on a very small scale, giving the functional groups mobility to bond with the paper.

Softening has been observed when the toner film reaches a temperature of 80° C.-100° C. with stronger softening above 100° C. In order to efficiently achieve the desired polymer flow and functional group mobility, it is advantageous to heat the toner film but not the bulk of the substrate. Since the toner film is only a few microns thick, the energy needed to heat the toner is much less than the energy needed to heat the full thickness of the substrate. Also, although the temperature at which increased adhesion occurs varies depending on the time at temperature, significantly improved adhesion is achieved in less than 250 ms at temperatures above 100° C. Accordingly, a high heat flux directed to the surface of the substrate allows preferential heating of the toner film to the required polymer flow temperatures before the heat is conducted substantially into the bulk of the substrate.

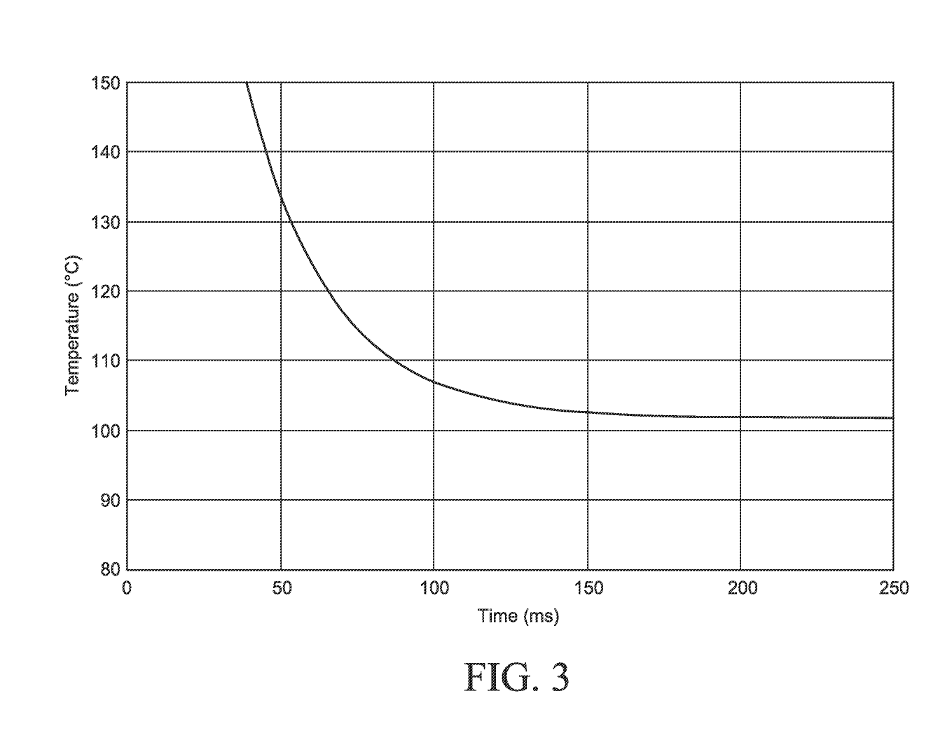

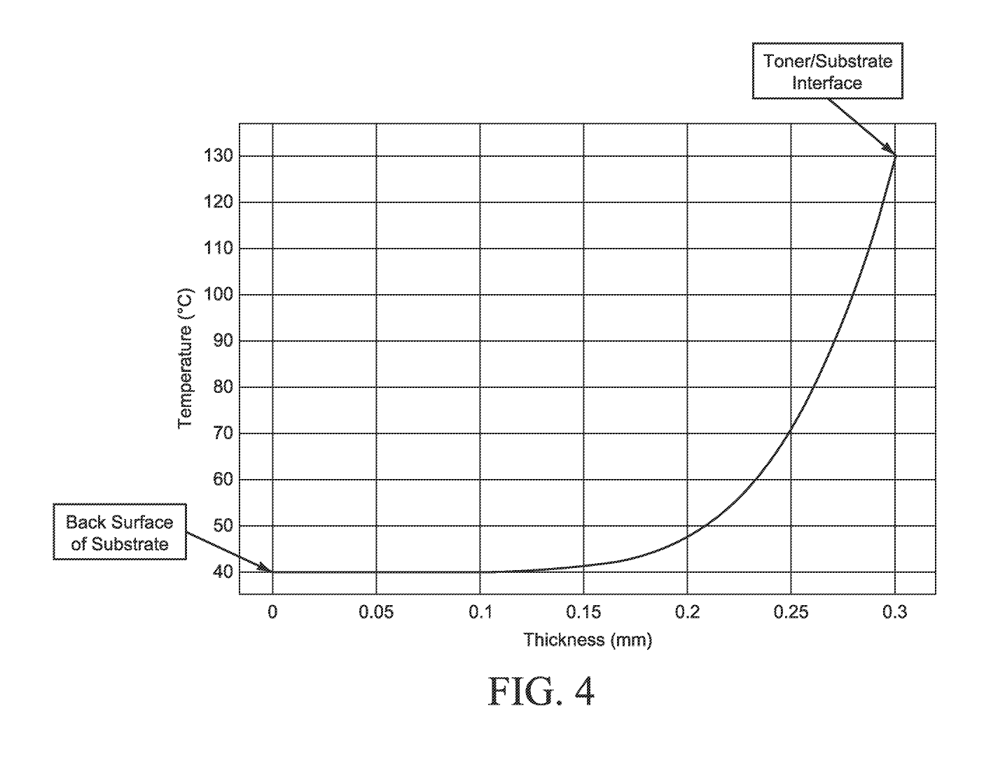

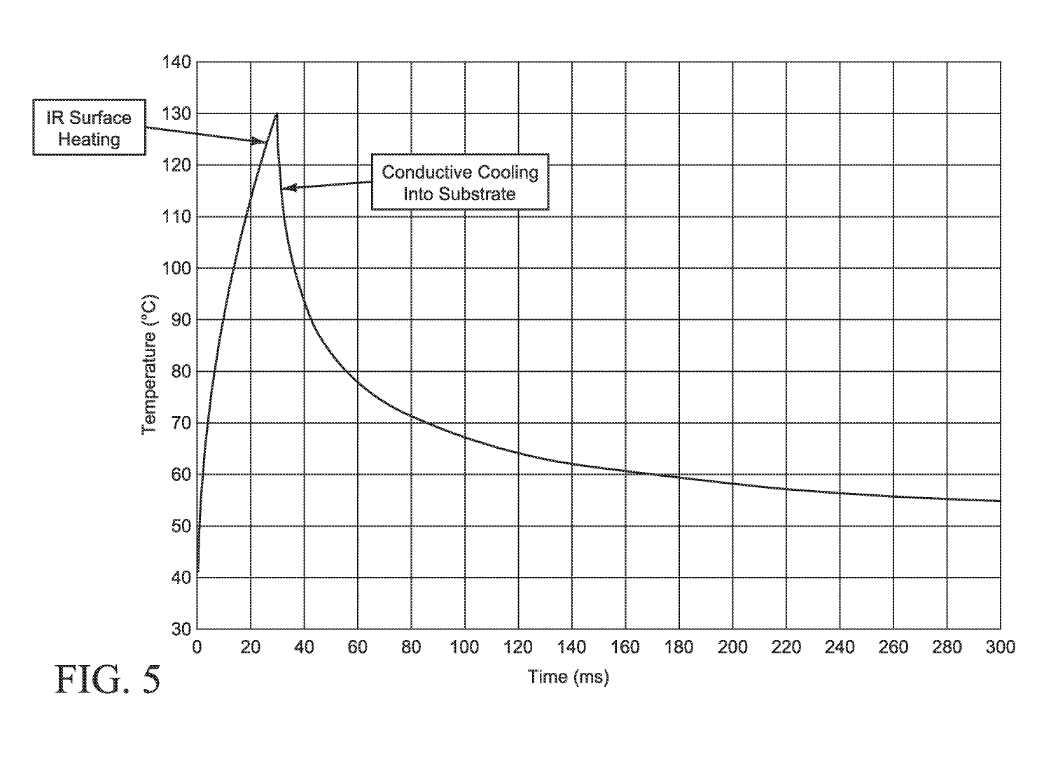

For one example, the graph of FIG. 3 illustrates the time and temperature to achieve 95% adhesion for black toner printed on one type of mid-weight 148 gsm paper print substrate. As shown in FIG. 3, heating the toner film to 102° C. in about 225 ms will achieve 95% adhesion. Increasing the peak temperature to 130° C. drops the time needed to reach the temperature to about 55 ms for 95% adhesion. FIGS. 4 and 5 are graphs illustrating thermal profiles for rapidly heating the toner film on a paper print substrate. FIG. 4 shows the temperature profile across the thickness of a heavy weight 324 gsm paper at the exit of an IR heater that delivers 200 kW/m² heat flux to the toner film on the surface of the substrate. FIG. 5 shows heating and cooling profiles as a function of time for the same heavy weight paper. As shown in FIG. 4, the temperature drops precipitously from 130° C. at the front surface interface between the toner film and the paper to a cool 40° C. at the back surface of the paper. As shown in FIG. 5, the temperature of the toner film at the surface of the paper drops rapidly after heating as the surface heat conducts through the cooler bulk of the paper. Thus, in addition to better energy efficiency, fast heating at the surface of the paper also allows passive conductive cooling into the bulk of the paper.

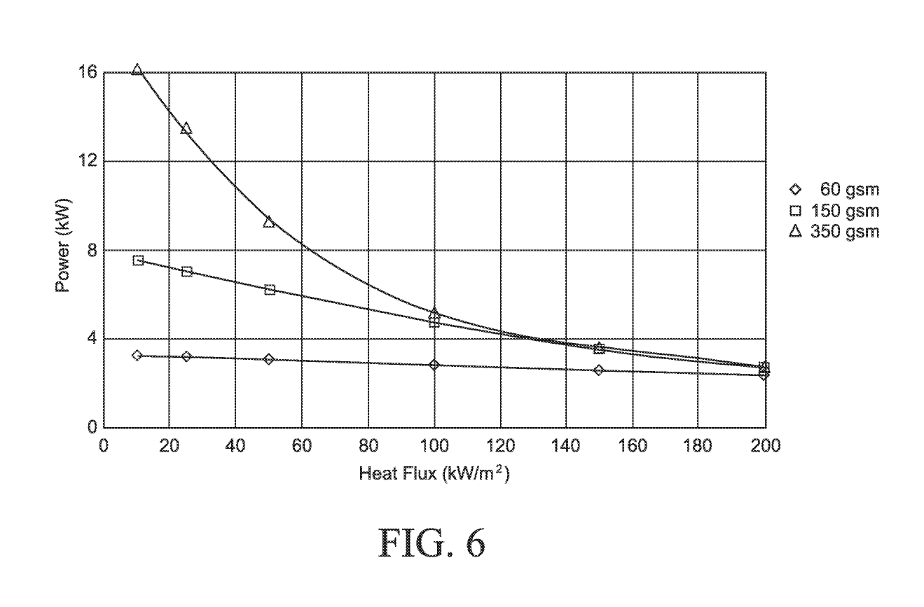

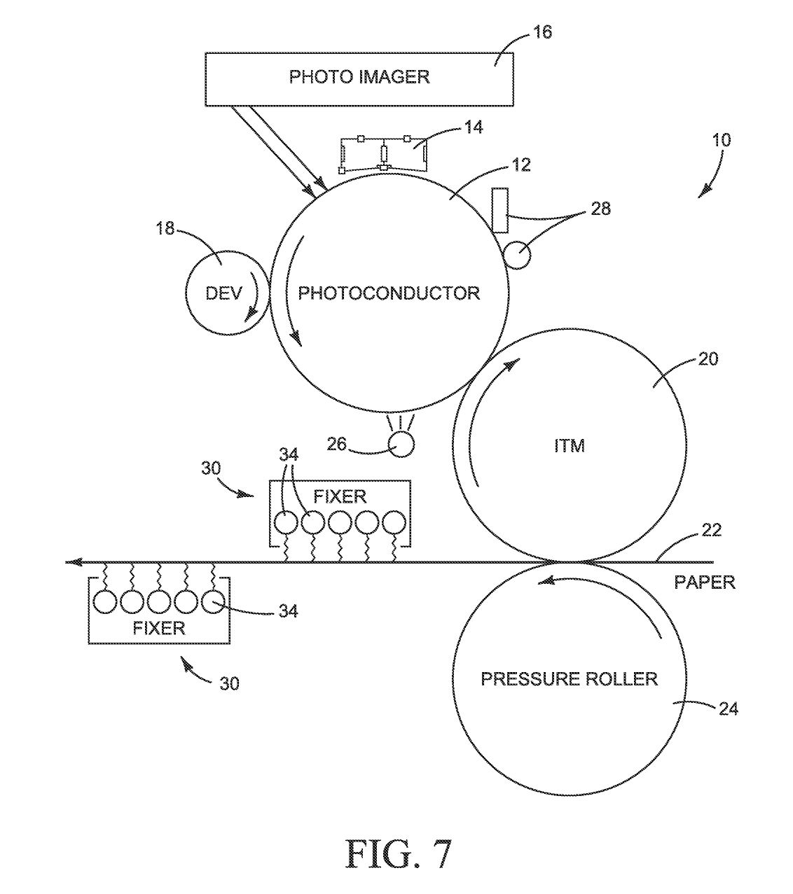

In the example shown in FIGS. 1 and 2, fixer 30 is implemented as an IR (infrared) heater 30 located over output conveyor 32 (FIG. 2) and capable of delivering 20 kW/m² to 400 kW/m² to the surface of substrate 22. An IR heater 30, for example, includes a series of IR lamps 34 focused on the surface of substrate 22 moving along conveyor 32. (In the example shown in FIG. 7, printer 10 includes two fixers 30 staggered along the output path on each side of substrate 22 for fixing duplex toner images.) High heat flux into the toner film at the surface of the print substrate allows preferential heating of the surface before the heat is conducted substantially into the substrate. As shown in the graph of FIG. 6, there is significantly reduced power consumption for more rapid heating (through higher heat flux) particularly as the weight of the paper increases. For example, and referring to FIG. 6, a heater that delivers a heat flux of only 25 kW/m² would require about 7 kW to heat the toner film on a mid-weight 150 gsm paper to 130° C. while a heater that delivers 200 kW/m² would require only about 3 kW. Also, because a higher heat flux shortens the heating time required to reach the desired softening temperature, about 25 ms in the example of FIG. 5, printer throughput is largely unaffected by the fixer. Testing indicates short to mid wavelength, 0.6 μm-2.4 μm, IR heaters were able to provide the highest heat fluxes that still had relatively uniform absorption across the toner colors (CMYK).

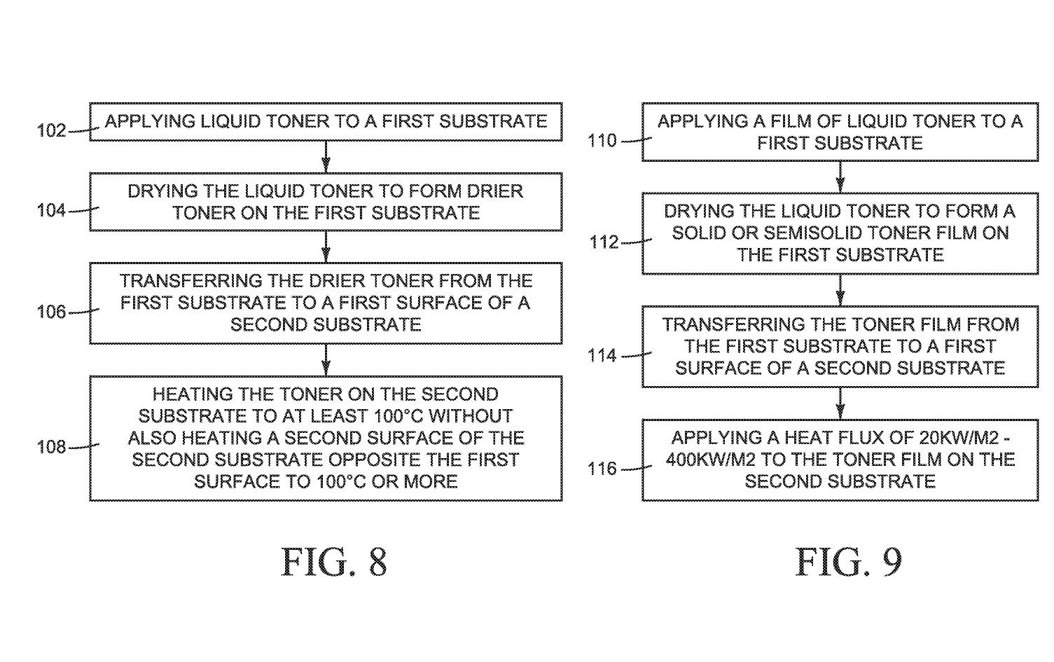

FIGS. 8 and 9 illustrate example printing methods using a fixer such as fixer 30 in FIGS. 1 and 2. In the example shown in FIG. 8, liquid toner is applied to a first substrate (step 102), such as ITM 20 in FIGS. 1 and 2, and dried to form drier toner on the first substrate (step 104). The drier toner is transferred from the first substrate to a first surface of a second substrate (step 106), such as the front side of print substrate 22 in FIGS. 1 and 2. Then, the toner is heated on the second substrate to at least 100° C. without also heating a second surface of the second substrate opposite the first surface, such as the back side of substrate 22 in FIGS. 1 and 2, to 100° C. or more (step 108). In one specific example, the toner on the second substrate is heated to a peak temperature of 100° C.-150° C. in 250 ms-40 ms and the time to reach the peak temperature decreases as the temperature increases.

In the example shown in FIG. 9, a film of liquid toner is applied to a first substrate (step 110) and liquid toner is dried to form a solid or semisolid toner film on the first substrate (step 112). Then, the toner film is transferred from the first substrate to a first surface of a second substrate (step 114) and a heat flux of 20 kW/m²-400 kW/m² is applied to the toner film on the second substrate (step 116). In one specific example, the heat flux is applied so that the toner film reaches 100° C.-150° C. in 250 ms-40 ms.

The examples shown in the figures and described above illustrate but do not limit the invention. Other examples may be made and implemented. Therefore, the foregoing description should not be construed to limit the scope of the disclosure, which is defined in the following claims.

What is claimed is:

1. A printer, comprising:
a photoconductor;
an imager to form a pattern of a desired image on the photoconductor;
an image developer to apply liquid toner to the photoconductor;
a transfer member to transfer a toner image from the photoconductor to a print substrate; and
a fixer configured to, without contacting the toner image, apply a heat flux of 20 kW/m²-400 kW/m² to the toner image on the print substrate.

2. The printer of claim 1, where the fixer comprises an infrared lamp.

3. The printer of claim 2, where the fixer is configured to heat the toner image on the print substrate to a peak temperature of at least 100° C. in not more than 250 ms.

4. The printer of claim 3, where the fixer is configured to heat the toner image to a peak temperature of 100° C.-150° C. in 250 ms-40 ms and the time to temperature decreases as the temperature increases.

5. The printer of claim 4, where the infrared lamp is configured to expose the toner image to infrared light having a wavelength of 0.6 μm-2.4 μm.

6. A printer, comprising:
a forming device configured to form a solid or semisolid toner film on a print substrate; and
a fixer configured to, without contacting the toner film, soften the toner film on the print substrate until polymers in the toner are mobile enough to allow polymer functional groups to bond with the print substrate.

7. The printer of claim 6, where the forming device is configured to apply a film of liquid toner to a transfer member, dry the toner film on the transfer member to a solid or semisolid, and transfer the toner film from the transfer member to the print substrate.

8. The printer of claim 6, where the fixer is configured to heat the toner film on the print substrate to a peak temperature of 100° C.-150° C. in 250 ms-40 ms and the time to temperature decreases as the temperature increases.

9. The printer of claim 6, where the fixer comprises an infrared lamp configured to deliver a heat flux of 20 kW/m²-400 kW/m² to the toner film on the print substrate.

10. The printer of claim 9, where the infrared lamp is configured to emit infrared light having a wavelength of 0.6 μm-2.4 μm.

11. A printing method, comprising:
forming a solid or semisolid toner film on a first surface of a substrate; and
heating the toner film to a peak temperature of at least 100° C. without also heating a second surface of the substrate opposite the first surface to 100° C. or more.

12. The method of claim 11, where the heating includes applying a heat flux of 20 kW/m²-400 kW/m² to the toner film.

13. The method of claim 12, where the applying a heat flux includes applying a heat flux of 20 kW/m² -400 kW/m² to the toner film until the toner film reaches 100° C.-150° C. in 250 ms-40 ms.

14. The method of claim 13, where the applying a heat flux includes exposing the toner film to infrared light having a wavelength of 0.6 μm-2.4 μm.
